(19) United States
(12) Patent Application Publication
(10) Pub. No.: US 2002/0191625 A1
(43) Pub. Date: Dec. 19, 2002

(54) Table-based correlation of base and enhancement layer frames

(76) Inventors: Patrick Kelly, San Francisco, CA (US); Anindya Haldar, Cupertino, CA (US); Ganesh Rajan, Saratoga, CA (US)

Correspondence Address: GARY CARY WARE & FREIDENRICH LLP, 1755 EMBARCADERO ROAD, PALO ALTO, CA, 94303-3340, US

(21) Appl. No.: 10/150,418

(22) Filed: May 17, 2002

Related U.S. Application Data
(60) Provisional application No. 60/293,751, filed on May 25, 2001.

(51) Int. Cl. H04L 12/28

(52) U.S. Cl. 370/412; 370/395.4

(57) ABSTRACT

Data packets from different layers of a layered data stream are correlated in time. The layered data stream has a base layer and one or more enhancement layers. The method builds a table of entries, with each entry including one or more received data packets. Each data packet has a corresponding time stamp indicating when that data packet can be sent to a decoder for processing. The entries in the table are indexed according to the time stamps of the received data packets, where each entry is associated with a temporal window and data packets that have time stamps within a given temporal window are included within the entry associated with the given temporal window.

This application claims the priority of a Provisional Application No. 60/293,751 filed on May 25, 2001, entitled Table-Based Correlation of Base and Enhancement Layer Frames.

### TECHNICAL FIELD

The present invention relates to a method of correlating, in time, a plurality of media streams for decoding, and more particularly to using a table to correlate in time a plurality of media streams for decoding.

### BACKGROUND OF THE INVENTION

The MPEG-4 specification supports media scalability in a variety of ways. One such mechanism is the base/enhancement layer “tool,” through which authors create streams that, effectively, have more than one component. The “base layer” component provides a low-resolution bit stream. For example, in the case of video, this might be a so-called Quarter Common Intermediate Format (QCIF) stream with each frame containing 144 lines and 176 pixels per line. The corresponding “enhancement layer” stream provides additional information so that a properly configured video decoder can combine it with the base layer and generate higher-resolution frames. For instance, a QCIF base layer might be enhanced so that a decoder can output Common Intermediate Format (CIF)-sized video frames (288 lines and 352 pixels per line). It is possible to have several enhancement layers.

Such scalability is desirable for a variety of reasons. These include the dynamic detection of bandwidth capabilities followed by the dynamic selection of the appropriate configuration to serve. A content provider might offer a base-layer only option to low bandwidth users and a combined base and enhancement layer configuration for those users with high bandwidth connections. Other uses of scalability are also possible. For instance, the provision of a base layer at one cost and the addition of the enhancement layer at an additional charge in a video-on-demand scenario. More generally, the ability to correlate, in time, data from two separate streams is a powerful feature in streaming media architectures. Many applications of this functionality are possible including correlating data from several streams to enforce order dependency relationships when processing the input from the separate streams.

On the client side the possibility of multiple “layers” of media data introduces complexity into the system architecture. A significant challenge is the need to correlate, in time, the payloads in transmitted data packets (the payloads are frequently referred to as access units or AUs) from the base and enhancement layers so that they can be fed to a decoder as a single unit. This single unit approach is typically recommended for the decoder to properly process multiple layer data.

In MPEG-4 the base and enhancement layers for a media stream are transmitted as separate elementary streams. Each elementary stream is independently segmented into a set of data packets that are transmitted, over time, to the client. Each such data packet contains an AU payload. This payload may contain either a portion of, or a complete, AU. In the case where an AU is transmitted in several data packets, a means for reconstructing the AU by reassembling the individual data packets is available. Explicit temporal correlation information between the AUs in separate elementary streams is not available. Each elementary stream is identified by a unique ID value. As a result, each AU effectively has a unique ID value that identifies the stream to which it belongs.

AUs from the base and enhancement layer streams do contain time stamps indicating the sequence in which the AUs in a particular stream are to be input to the decoder for processing. Time stamps for the base layer of a video sequence running at 30 frames per second might begin as 0, 33, 66, 100, 133, 166, etc. (in milliseconds).

However, there is no guarantee, in general, that the time stamps between two streams that are logically correlated will have precisely aligned time stamps. It may be the case that the machinery for generating the time stamps of the separate streams does so in a fashion that produces variations in the time stamps between AUs that are to be submitted to the decoder simultaneously. This is illustrated in FIG. 6. The time stamps of some AUs e.g. (1,2) are aligned in time. However, the timestamps of others may not be so well behaved.

For instance, frame (3) of the enhancement layer has a time stamp that is earlier than the corresponding base layer frame. While in frames (4, 5) the base layer AUs are earlier than those of their associated enhancement layer frames.

It is desirable that the correlation strategy supports the scenarios shown in Table 1:

TABLE 1
AU Packet Correlation Constraints

Decoder configured for base and enhancement layers but only base layer arrives.

This is a valid situation.

Decoder configured for base and enhancement layers but no base layer arrives. This

is typically an erroneous situation. However, it is possible that some decoders will be
able to handle this situation. Further, from a systems perspective, it is preferable to let
the decoder determine whether or not it should continue processing.

Base and enhancement layers are not correlated in time. Temporally correlated layers

are typical in spatial scalability. Temporal scalability will have base and enhancement
layer packets separated in time.

### SUMMARY OF THE INVENTION

In the present invention a method of correlating data packets from different layers of a layered data stream is disclosed. The layered data stream has a base layer and one or more enhancement layers. The method comprises building a table of entries, with each entry including one or more received data packets. Each data packet has a corresponding time stamp indicating when that data packet can be sent to a decoder for processing. The entries in the table are indexed according to the time stamps of the received data packets, where each entry is associated with a temporal window and data packets that have time stamps within a given temporal window are included within the entry associated with the given temporal window. The present invention also relates to a computer program product for accomplishing the foregoing method.

### BRIEF DESCRIPTION OF THE DRAWINGS

FIG. 1 is a schematic block level diagram showing a computer for generating audiovisual streams to be transmitted over a private or public network to a number of various devices each capable of decoding the streams using the method of the present invention.

FIG. 2 is a flow chart showing the overall processing flow according to one aspect of the invention.

FIG. 3 is a flow chart showing the operations that are performed in comparing new AUs to the entries in the AU table.

FIG. 4 is a diagram showing a data structure that can be used to pass base and enhancement layer data into the decoder.

FIG. 5 is a diagram showing an example of a table for the method of the present invention.

FIG. 6 is a diagram showing the relationship, in time, between data packets from two related streams.

FIG. 7 indicates the structure of an entry in the AU correlation table.

FIG. 8 shows a task engine processing flow operation.

### DETAILED DESCRIPTION

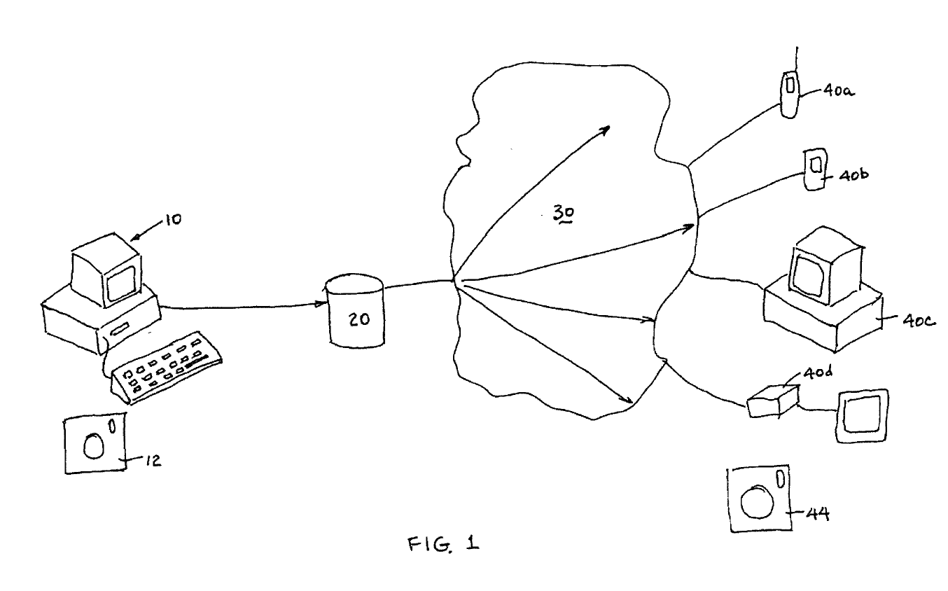

Referring to FIG. 1 there is shown a computer 10 with its associated components of microprocessor, memory, hard drive, monitor, input/output device, and a computer product (software) 12. The computer 10 can be a well-known workstation, PC or even a mainframe. The computer 10 along with software 12 converts an audiovisual scene into an audiovisual stream that is then stored on a server 20 for suitable transmission. In the preferred embodiment, the method of encoding is in accordance with the MPEG 4 standard. In accordance with the MPEG 4 standard, an audiovisual scene can be converted into one or more base layer streams of data and one or more enhancement streams of data (hereinafter collectively referred to as “the audiovisual streaming data”, or “an audiovisual streaming signal”).

The server 20 is capable of being connected to a network 30, either private or public, such as the internet, for transmission of the audiovisual streaming data thereon. The server 20 transmits, over the network, an audiovisual streaming signal, that has been encoded by the computer 10 using the computer product 12.

The audiovisual streaming signal transmitted over the network 30 can be received by a plurality of receiving devices 40(a-d). The receiving devices 40(a-d) can comprise a cellular phone 40a, a personal digital assistant (PDA) 40b, another computer 40c, or a set-top box 40d connected to an appropriate video monitor or television 42. Because the audiovisual streaming signal is transmitted over a network 30, such as the internet 30, in packets, each packet carries with it a time stamp indicating the appropriate sequence to re-assemble the entire audiovisual streaming signal once it is received by a receiving device 40(a-d). However, as previously discussed, the audiovisual streaming signal can comprise a base layer data stream and one or more enhancement layer data streams. Depending upon the capability of the receiving device 40, either one or a plurality of data streams may be used in the decoding process. In the event the base layer data stream and the one or more enhancement layer data streams are to be used in the decoding process, both types of layers of data stream must be matched temporally so that decoding can occur. This matching requirement creates the need for the present invention. Each of the receiving devices 40(a-d) executes a computer product 44 that is capable of performing the decoding method described hereinafter.

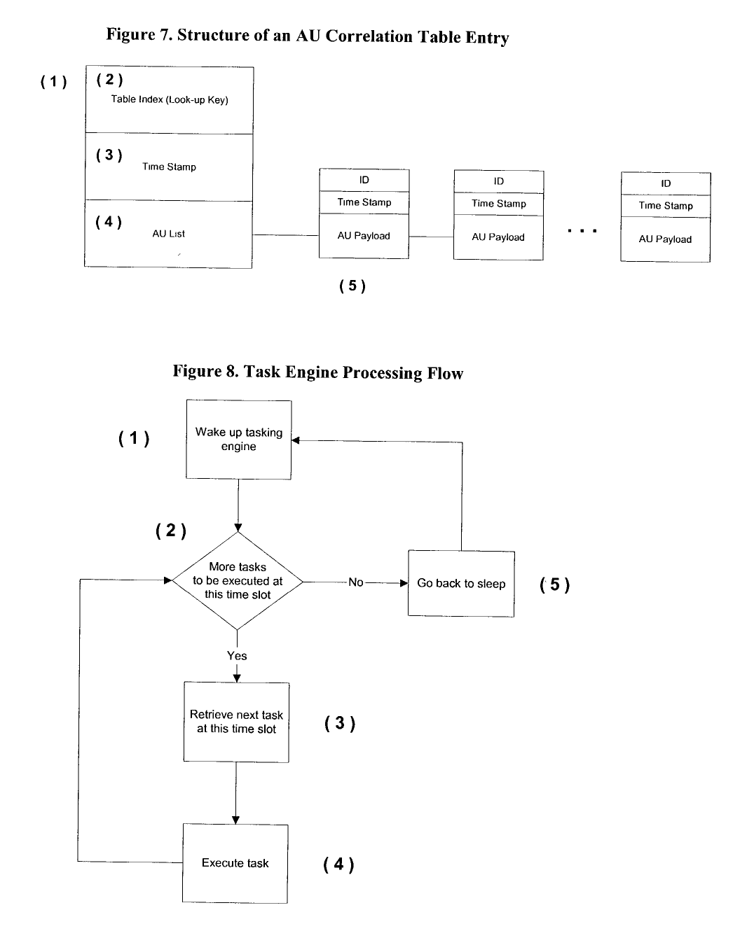

In the present invention, a table of access units is built. This table is referred to as the “AU Correlation Table.” An example of such a table is shown in FIG. 5. The table has a number of entries whose structure is detailed in FIG. 7. Each contains a “header” (7.1) that consists of an index (7.2) used to retrieve the entry from the table in look-up operations; a time-stamp (7.3) that indicates when the information in the entry should be used in a processing operation; and a list (7.4) of AUs (7.5).

As mentioned above, each AU has a time stamp, indicating the time at which the AU can be sent to the decoder for processing. As each AU arrives at the terminal, it is checked against a table of AUs indexed according to the decoding time of other AU's stored in the table. AUs from a particular stream are preferably checked against AUs from other streams, not against themselves, thus avoiding self-correlation. Those AUs that have time stamps within a temporal window are deemed to be correlated and are combined in the table and will sent to the decoder for processing as a single entity. The temporal window is a preferably adjustable parameter. As shown in FIG. 5, the windows depict, e.g. the time frame from t0 to t1, and from t1 to t2, etc. An adaptive scheme could be used to dynamically adjust the temporal window over time. Furthermore, the time at which the table-correlated frames are sent to the decoder is found by choosing one of the time stamps on the correlated packets. Typically, the base layer time stamp is selected. An average of all the time stamps could also be used. This selected time is used as the entry time stamp and determines the location of the entry within the table. It is used in subsequent comparison operations when checking a new AU against entries in the table.

It is assumed that when a decoder is first configured, the number of layers the decoder may receive is specified. Thus, when initialized and running, each decoder knows the maximum number of layers it may have to process. As indicated above, however, not all layers may arrive.

Furthermore, the present invention employs a tasking engine to schedule and execute time-sensitive computations. The tasking engine processing flow is shown in FIG. 8. A task is created for operations, such as decoding, that must be executed at a particular point in time. The task is then added to the engine that schedules the task based on its execution time. When the execution time of a task matures, the engine invokes the task's computation. The basic operation of the tasking engine is as follows. Periodically, the engine wakes up (8.1) and loops through all tasks that are scheduled for execution in the current time slot (8.2). For instance, the engine might wake up at time t and retrieve all tasks, currently in the task-queue, whose scheduled-at time is less than or equal to t (8.3). Each retrieved task is then executed (8.4). Once all the tasks in the time slot have been executed the task engine goes back to waiting (8.5).

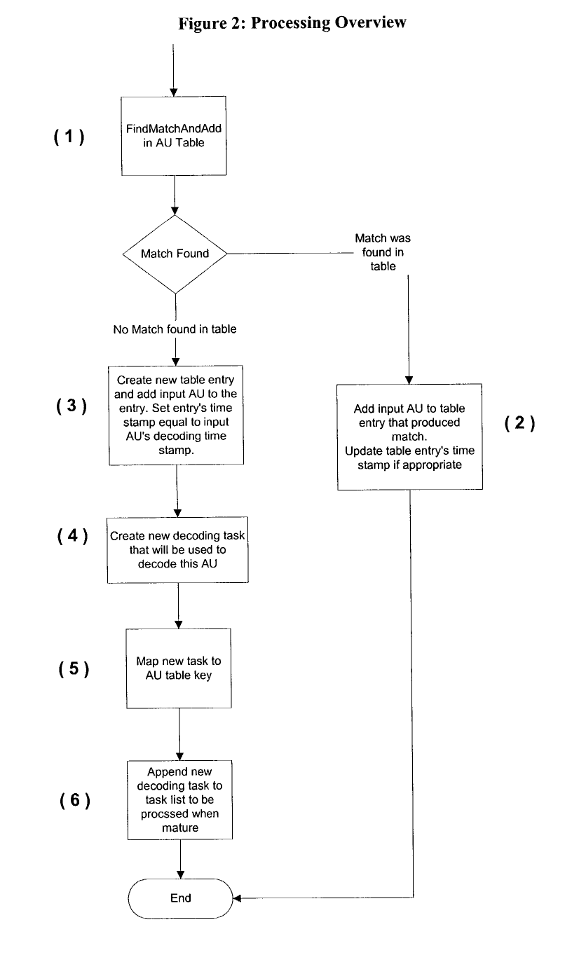

FIG. 2. shows the overall processing flow according to one aspect of the invention. When new AUs are input to the system, the AU table is checked to determine if there is a temporal match between the time stamp of the new AU and that of an entry in the table (2.1). If a match is found, the matched table entry is updated by adding the input AU to the list of AUs maintained by the entry (2.2). If desired, the timestamp of the entry can be updated with the timestamp of the input AU.

If there is no match, the input AU is added to the table. To do so, a new entry containing the input AU is created (2.3). Then a new decode task, to process the AU (and any others that may be subsequently appended to this entry) is created (2.4). A key that facilitates easy retrieval of the entry by the task is created and the entry is then added to the table using its key, retrieve the appropriate entry from the table, and process the AUs stored in the retrieved table entry.

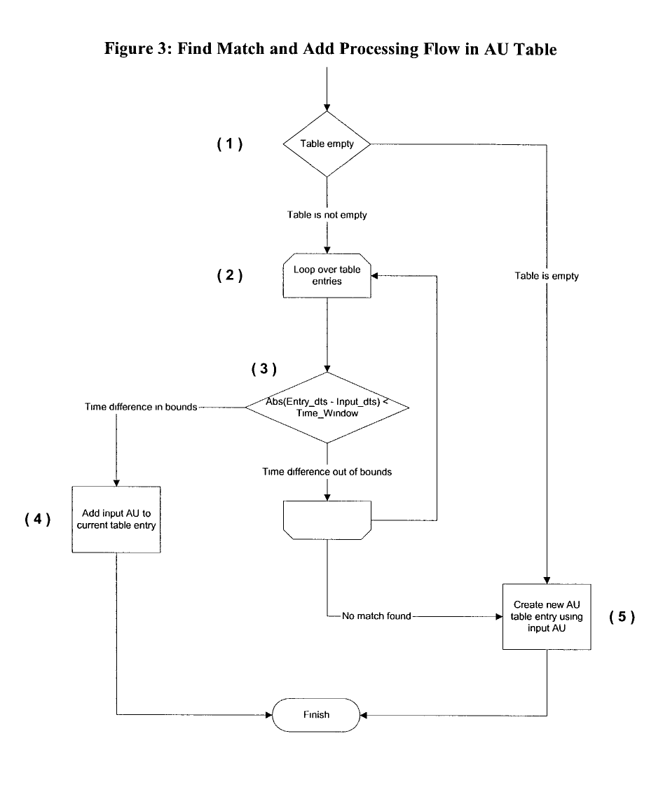

As noted above, if a match is found between the time stamp of the new AU and that of an entry in the AU table, then the matched AU table entry is updated to include this new AU and processing continues (2.2). A match is found when the time stamp of the new AU is within a temporal window associated with an entry in the table. FIG. 3 shows the operations that are performed in comparing input AUs to the entries in the AU table. If the table is empty or no match is found, a new AU entry is created and added to the table (3.5) as described above. If the table is not empty, the algorithm iterates over the entries (3.2) comparing the time-stamp of each against that of the input AU (3.3). The table can be organized to expedite this iteration, e.g. as a binary tree with time as discriminant. If the difference between the time-stamp of the input AU and that of a particular table entry is sufficiently small (3.4) the input AUs, including its id, time stamp and payload (several are shown in 7.5) is appended to the list of AUs (7.4) maintained by this table entry.

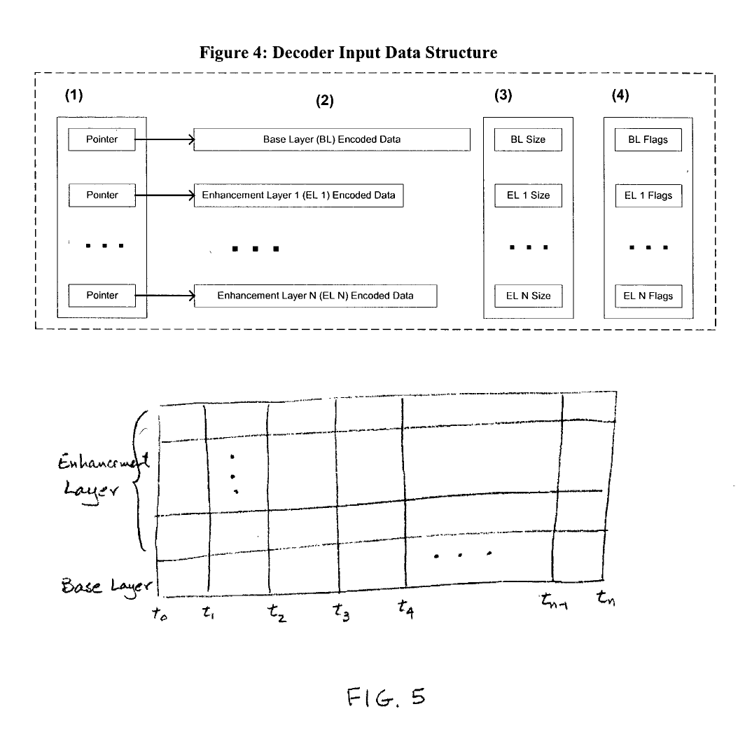

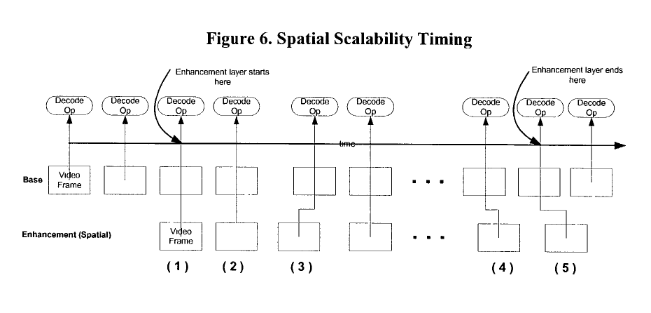

FIG. 4 shows a data structure that is used to pass base and enhancement layer data, or more generally, correlated data, into the decoder. Correlated, encoded data packets are aggregated in the AU table as discussed above and indicated in FIG. 7 (7.4). Multiple arrays of encoded data, one for the base layer and one for each of the enhancement layers (4.2) are sent to the decoder via a set of pointers to arrays. Pointers (4.1) are used so that a NULL value in one of the pointer entries indicates that there is no data available for this layer. The size of each such array can be different. The size for each array is also sent to the decoder (4.3). In addition, a collection of flags, one for each (4.1) are used so that a NULL value in one of the pointer entries indicates that there is no data available for this layer. The size of each such array can be different. The size for each array is also sent to the decoder (4.3). In addition, a collection of flags, one for each layer with each represented using an unsigned 32-bit value, is also provided. These flags can be used for a variety of dynamic configuration tasks (4.4). One use of the flags is to specify an explicit ordering of the layers. As mentioned above, the decoder is configured before decoding begins so that it is prepared to accept multiple data packets to be processed in a single decoding operation.

The present invention has been described above in terms of a presently preferred embodiment so that an understanding of the present invention can be conveyed. There are, however, many configurations for the system not specifically described herein but with which the present invention is applicable. The present invention should therefore not be seen as limited to the particular embodiment described herein, but rather, it should be understood that the present invention has wide applicability with respect to correlation of data streams generally. All modifications, variations, or equivalent arrangements and implementations that are within the scope of the attached claims should therefore be considered within the scope of the invention.

What is claimed:

1. A method of correlating data packets from different layers of a layered data stream having a base layer and one or more enhancement layers, comprising:
building a table of entries, each entry including one or more received data packets, wherein each data packet has a corresponding time stamp indicating when that data packet can be sent to a decoder for processing; and
indexing the entries in the table according to the time stamps of the received data packets, wherein each entry is associated with a temporal window and data packets that have time stamps within a given temporal window are included within the entry associated with the given temporal window.

2. A method as defined in claim 1, additionally comprising:
receiving a new data packet;
comparing the decoding time of the new data packet to the temporal window of one or more entries in the table;
if the decoding time of the new data packet is within a temporal window associated with an entry, then adding the new data packet to that entry.

3. A method as defined in claim 1, additionally comprising:
receiving a new data packet;
comparing the decoding time of the new data packet to the temporal window of one or more entries in the table;
if the decoding time of the new data packet is not within the temporal windows of any of the entries, then creating a new entry in the table and including the new data packet within the new entry.

4. A method as defined in claim 1, additionally comprising:
if the time stamp of the new data packet is not within the temporal windows of any of the entries, then also scheduling a task with the decoder, the task being related to decoding of data packets in the new entry; and
mapping the task to the new entry in the table;
appending the new task to a task list.

5. A method as defined in claim 1, additionally comprising:
sending all of the data packets within an entry to a decoder for processing as a single entity.

6. A method of correlating received data packets from different layers of a layered data stream having a base layer and one or more enhancement layers, each data packet having a corresponding time stamp indicating when that data packet can be sent to a decoder for processing, the method comprising:
receiving a new data packet;
comparing the time stamp of the new data packet to one or more entries in a table of entries, each entry including one or more received data packets and each entry having a corresponding temporal window;
if the time stamp of the new data packet is within a temporal window associated with an entry, then adding the new data packet to that entry.

7. A method as defined in claim 6, additionally comprising:
sending all of the data packets within an entry to a decoder for decoding upon maturation of the time stamp associated with the entry.

8. A method as defined in claim 6, additionally comprising:
if the time stamp of the new data packet is not within the temporal windows of any of the entries, then creating a new entry in the table and including the new data packet within the new entry.

9. A computer product comprising:
a computer usable medium having computer readable program code embodied therein for use with a computer for receiving a plurality of data packets from different layers of a layered data stream for correlating the time between the different layers of said layered data stream, said computer readable program code comprising:
computer readable program code configured to cause said computer to construct a table having a first plurality of entries, with each entry having the same associated first timing period;
computer readable program code configured to cause said computer to receive a data packet, wherein said data packet having a corresponding time signal;
computer readable program code configured to cause said computer to compare said time signal of said received data packet to said first timing period, and to associate said received data packet with one of said first plurality of entries in the event said time signal of said received data packet is within said first timing period; and
computer readable program code configured to cause said computer to decode all data packets associated with the entry in said table having the same first timing period.

10. The computer product of claim 9 further comprising:
computer readable program code configured to cause said computer to construct a second plurality of entries, with each entry having the same associated second timing period, in the event said timing signal of said received data packet is not within the first timing period; and
computer readable program code configured to cause said computer to associate said received data packet with one of said second plurality of entries, in the event said time signal of said received data packet is within said second timing period.

11. The computer product of claim 9 wherein each entry is associated with a different layer.
